(19) United States
(12) Patent Application Publication
(10) Pub. No.: US 2024/0005952 A1
(43) Pub. Date: Jan. 4, 2024

(54) DATA STORAGE SYSTEM WITH DISK JUKEBOX

(71) Applicant: Seagate Technology LLC, Fremont, CA (US)

(72) Inventors: Riyan Alex Mendonsa, Edina, MN (US); Krishnan Subramanian, Shakopee, MN (US); Brett R. Herdendorf, Mound, MN (US); Jon D. Trantham, Chanhassen, MN (US); Mehmet Fatih Erden, St. Louis Park, MN (US)

(21) Appl. No.: 18/212,283

(22) Filed: Jun. 21, 2023

Related U.S. Application Data
(60) Provisional application No. 63/357,316, filed on Jun. 30, 2022.

(51) Int. Cl. G11B 5/48

(52) U.S. Cl. CPC G11B 5/4826

(57) ABSTRACT

A data storage apparatus includes a disk storage region in which magnetic disks are stored. A carrier mechanism picks up one or more of the magnetic disks and moves them to and from the disk storage region. A data access device of the apparatus includes a structure to receive the one or more magnetic disks from the carrier mechanism and spins the magnetic disks in place. One or more actuator arms are operable to move across a same surface of the one or more magnetic disks. Two or more read transducers are mounted to the actuator arms and operable to simultaneously read from the same surface of the one or more magnetic disks. Two or more write transducers are mounted to the actuator arms and operable to simultaneously write to the same surface of the one or more magnetic disks.

### CROSS-REFERENCE TO RELATED APPLICATIONS

This application claims the benefit of U.S. Provisional Application No. 63/357,316, filed Jun. 30, 2022, the disclosure of which is incorporated by reference herein in its entirety.

### SUMMARY

The present disclosure is directed to a data storage system. In one embodiment, a data storage apparatus includes a disk storage region in which a plurality of magnetic disks are stored. The apparatus includes a carrier mechanism for picking up one or more of the magnetic disks and moving the one or more magnetic disks to and from the disk storage region. A data access device of the apparatus includes a structure to receive the one or more magnetic disks from the carrier mechanism and facilitate spinning the one or more magnetic disks in place. One or more actuator arms are operable to move across a same surface of the one or more magnetic disks. Two or more read transducers are mounted to the one or more actuator arms and operable to simultaneously read from the same surface of the one or more magnetic disks. The data access device further includes two or more write transducers mounted to the one or more actuator arms and operable to simultaneously write to the same surface of the one or more magnetic disks.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a schematic diagram of a data storage system according to an example embodiment;

FIG. 2 is a perspective view showing physical layout of a data storage system according to another example embodiment;

FIGS. 3, 4, and 5 are top views of data access devices for reading and writing disks according to example embodiments;

FIG. 6 is a flowchart illustrating area management and queuing for a data access device according to an example embodiment;

FIGS. 7A and 7B are top views of data access devices using multiple head gimbal assemblies for reading the same surface according to example embodiments;

FIG. 8 is a perspective view of a read/write head according to an example embodiment;

FIG. 9 is an air-bearing-surface view of read and write transducers according to an example embodiment;

FIGS. 10 and 11 are schematic diagrams showing shingled magnetic recording bands according to an example embodiment;

FIGS. 12 and 13 are air-bearing-surface views of interlaced magnetic recording write transducers according to example embodiment; and

FIG. 14 is a flowchart of a method according to an example embodiment;

### DETAILED DESCRIPTION

The present disclosure is generally related to storage system using data magnetically recorded on disks. Since the advent of computing, there has been a need for both short-term and long-term persistent storage. Short-term data storage may include temporary persistent storage such as data caches, as well as storage of primary user data that changes frequently, e.g., a document being edited. This user data may also remain on the same storage device once it is no longer being updated (e.g., mid-term storage), and in some cases may be moved or copied elsewhere, e.g., cold storage using optical media, hard disk, magnetic tape, etc. for long term storage.

A number of technologies have evolved through the years to provide these types of persistent storage, including hard disk drives (HDD), floppy disk drives (FDD), optical media such as compact disk (CD), magnetic tape, and flash memory. Currently, HDD and flash memory are the popular forms of short-term and mid-term storage due to their relative speed compared to other types of media. For long term storage, HDD and tape tend to dominate, due to their relative low cost per unit of storage.

The HDD tends to occupy a middle ground between short-term and long-term storage. Performance of HDD is not as good as flash memory for short-term storage applications such as personal computing, although HDD is significantly cheaper than flash memory per unit of data stored. Conversely, tape holds a cost advantage over HDD for long-term storage (e.g., archiving), but HDD is typically more convenient and quicker to access than tape. An HDD is self-contained unit that, even while idle, can be automatically spun up to read the target data in a matter of seconds, whereas tape typically needs to be loaded into a tape drive and spooled to the target location on the tape, which takes much longer.

While the advent of high-capacity HDDs (e.g., greater than 10 TB), the HDD is catching up with tape as far as cost effectiveness. Even so, it is estimated that tape still holds around a 4× cost advantage over HDD. One reason for this is that the tape media (e.g., cartridges) itself is relatively inexpensive compared to an HDD. While the tape drives may be relatively expensive compared to a single HDD, being able to swap out cartridges allows the combination of drive and media to be much cheaper than HDD for large-scale, cold storage, e.g., petabyte scale.

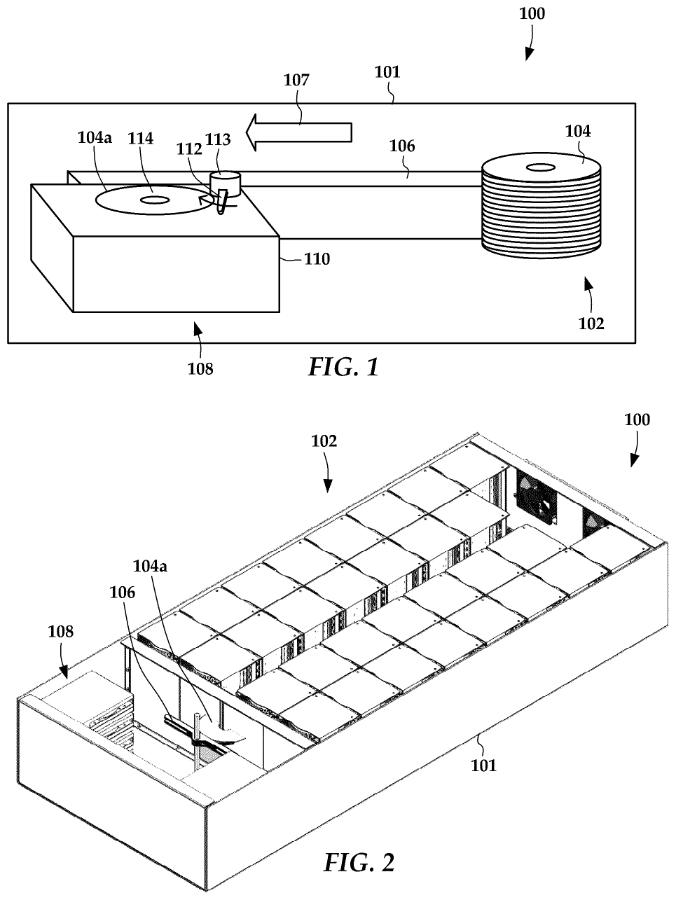

In order to reduce cost of the HDD for large scale storage, one system that may be able to reduce costs is a disk jukebox. In FIG. 1, a simplified diagram shows a disk jukebox storage system 100 according to an example embodiment. The system 100 may be a self-contained apparatus housed in a single enclosure 101 such as a rack mountable unit. The system 100 includes a disk storage region 102 in which a plurality of magnetic disks 104 are stored. A carrier mechanism 106 is configured to pick up one or more of the magnetic disks 104a and move the one or more magnetic disks (as indicated by arrow 107) to and from the disk storage region 102. The same carrier mechanism 106 may also be configured to move disks 104a back to the disk storage region 102, or a separate carrier mechanism could be used.

The system 100 includes a data access device 108 that includes a structure 110 to receive the one or more magnetic disks 104a from the carrier mechanism 106 and facilitate spinning the one or more disks 104a in place, e.g., via a spindle motor. One or more actuator arms 112 are operable to move across a same surface 114 of the one or more disks 104a. In this example, there are two actuator arms 112, one for the top surface 114 of the disk 104a and another for the bottom surface. The arms 112 are driven by a single actuator 113, e.g., a voice coil motor (VCM) that rotates the arms 112 across the disk. The system 100 may include multiple data access devices 108, such that one or more devices 108 are reading or writing data while a disk 104a is being loaded or unloaded from another data access device 108. The data access devices 108 could operate in parallel in some embodiments, e.g., sending and receiving data over separate host interfaces. Also, each data access device 108 may read from and write to a stack of disks at a time instead of just the single disk 104a shown in FIG. 1.

A system 100 as shown in FIG. 1 can achieve lower cost per unit of storage than traditional disks because, given large enough storage capacity, most of the cost of the system is in the disks themselves. While the carrier mechanism 106 and data access device 108 may be much more expensive than analogous components of a conventional HDD (and a conventional HDD would not have anything analogous to the carrier mechanism 106), the cost of these components relative to the whole system 100 are low assuming a large number of disks 104 are used. In FIG. 2, a perspective view showing a physical layout of the system 100 according to an example embodiment.

The system 100 may be slower than an array of conventional HDDs in accessing a given stored file due to the movement of the disks 104 between the storage region 102 and the data access device 108. However, once a targeted disk is loaded, the data access device 108 can provide relatively fast random access of data on the disk surfaces (at least compared to tape random access). Additional features may be included to enhance performance of the system 100 once a disk is loaded to the data access device 108 in order to offset the start time latency of disk loading. In particular, multiple read and write transducers may operate in parallel on a given disk surface, increasing sequential data throughput.

While not seen in the view of FIG. 1, two or more read transducers are mounted to the one or more actuator arms 112 and operable to simultaneously read from the same surface 114 of the one or more disks 104a. In this example, the two or more read transducers could be mounted to a single arm 112, e.g., commonly integrated into a read head at an end of the arm 112 or into two or more heads on each arm 112. Similar to the read transducers, two or more write transducers may also be mounted to the one or more actuator arms 112 and operable to simultaneously write to the same surface of the one or more disks.

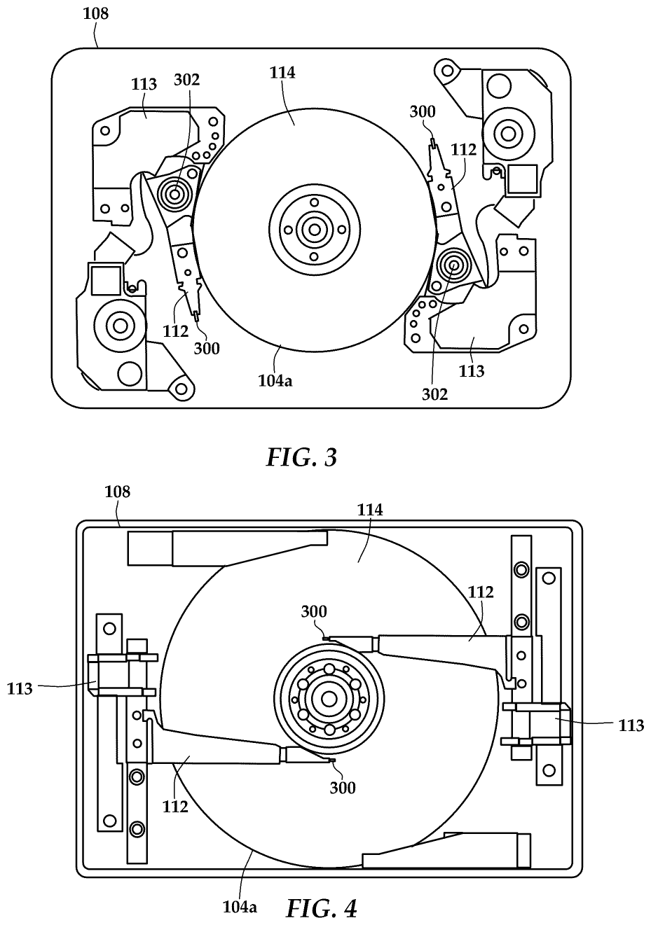

Another way to incorporate multiple read and write transducers that can simultaneously read the same disk surface is to use two or more independent actuators and/or arms. While more mechanically complicated, this can increase the advantages of parallelism, because different transducers can access different parts of the surface (e.g., different non-adjacent tracks) at the same time. In FIG. 3, a top view shows a data access device 108 according to one embodiment that uses two VCM actuators 113 that rotate two rotary arms 112 around two separate axes 302. Heads 300 are mounted on the distal end of each of the arms 112 and can be independently positioned over the surface 114 of the disk 104a.

In FIG. 4, a top view shows a data access device 108 according to another embodiment that uses two linearly driven actuators 113 that move two zero-skew arms 112 across the disk surface 114. The actuators 113 and arms 112 are separately located around the disk 104a. Heads 300 are mounted on the distal end of each of the arms 112 and can be independently positioned over the surface 114 of the disk 104a. The heads 300 in this arrangement may have slower seek times compared to rotating arms, but they can read and write with virtually zero skew, which can improve performance near the inner and outer diameter of the disk 104a compared to a rotary arm.

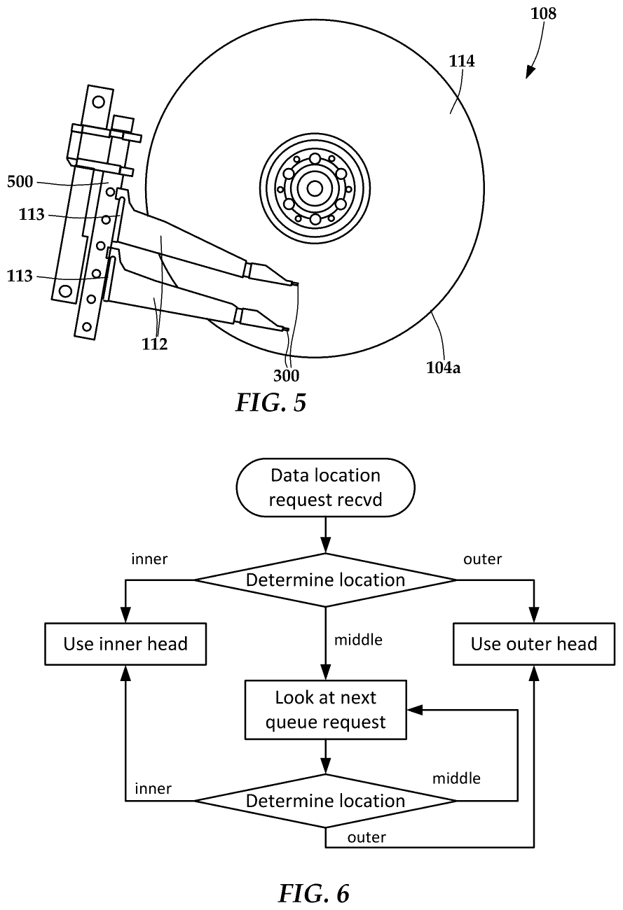

In FIG. 5, a top view shows a data access device 108 that uses a zero-skew, multiple arm actuator according to another embodiment. Multiple coils act as linear actuators 113 that move along a single magnetic rail 500. Each actuator 113 is attached to an individual arm 112, each arm having a separate head 300 at its distal end. The zero-skew arms are linearly driven along a common path, in this case defined by the rail. The upper arm 112 may be assigned to read and write on an inner diameter region, and the lower arm 112 may be assigned to read and write on an outer diameter region, with either arm 112 arm being able to access the middle parts of the disk surface 114. In FIG. 6, a flowchart shows an algorithm for area management and queuing between the different arms 112 according to an example embodiment. Generally, this algorithm determines which of two heads will be used to service a data access request. This can be extended to more than two heads and arms, e.g., inner, middle, and outer heads.

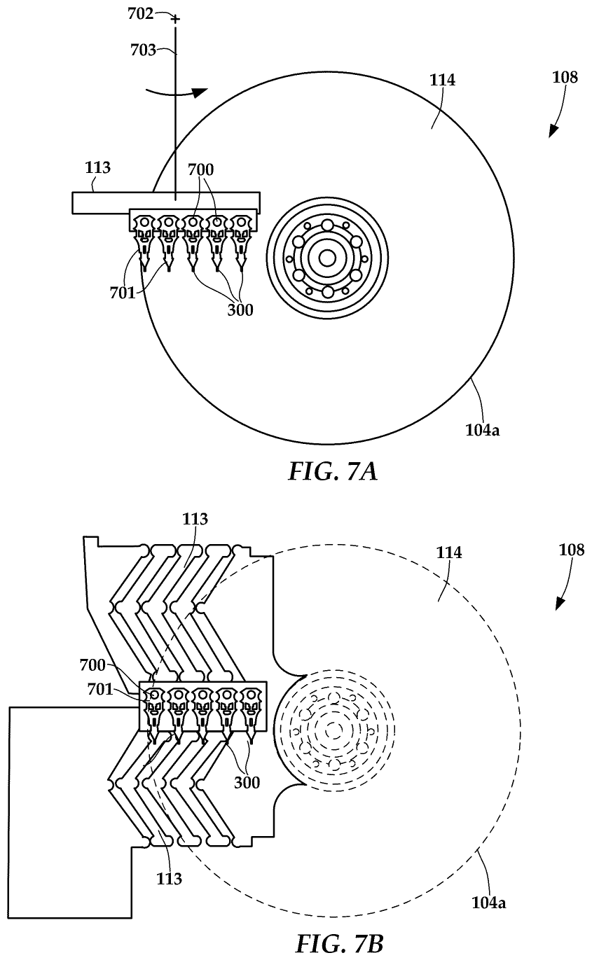

In FIG. 7A, a top view shows a data access device 108 that uses multiple head gimbal assemblies (HGA) 701 driven by a single actuator 113 according to another embodiment. In this example, the actuator 113 is a zero-skew, linear motion actuator, and each HGA 701 may be separately driven by a microactuator 700 for individual tracking control. In other embodiments, the HGAs 701 may be forked from an arm driven by a rotating VCM, as indicated by line 703 and pivot axis 702. Microactuators 700 may still be used with a rotating arm. In any of these embodiments, the individual heads 300 mounted to the HGAs 701 may read and write in parallel, each covering a different radial zone on the disk surface 114.

In FIG. 7B, a plan view shows a data access device 108 that uses multiple arms 112 on a single actuator 113 according to another embodiment. In this example, the actuator 113 uses a flexure that moves HGAs 701 linearly left-to-right in this figure. The disk-facing surfaces of HGAs 701 and heads 300 are seen in this view, which would be from the perspective of looking up from the disk surface. The actuator 113 includes flexures that could be driven by piezoelectric elements, shape memory alloys (e.g., nitinol), electromagnetic actuators, ultrasonic motor (also called inchworm or piezo crawler), etc. The actuation of the flexures is such that they maintain linear motion in the range of interest as well as can have the ability to move the heads away from the disk (in the z-direction as seen in FIG. 8), using a separate actuator similar to the ones mentioned above.

As noted above, the heads 300 in any of the embodiments described above may have multiple readers and writers. In FIG. 8, a diagram illustrates features of a read/write head 300 according to an example embodiment. The read/write head 300 may also be referred to herein interchangeably as a slider, head, write head, read head, recording head, etc. The read/write head 300 has a slider body 802 with a plurality of read and write transducers 808 at a media-facing surface 812 that are held proximate to a surface of a magnetic recording medium (not shown), e.g., a magnetic disk.

The recording head 300 may use conventional recording (e.g., perpendicular magnetic recording) or may use some sort of energy assistance for recording. An example of energy-assisted recording is heat-assisted magnetic recording (HAMR), where a laser is used to form a hot spot on the recording medium while recording. Other types of energy-assisted recording include microwave assisted magnetic recording (MAMR) in which a spin torque oscillator shapes the magnetic fields to write smaller bits.

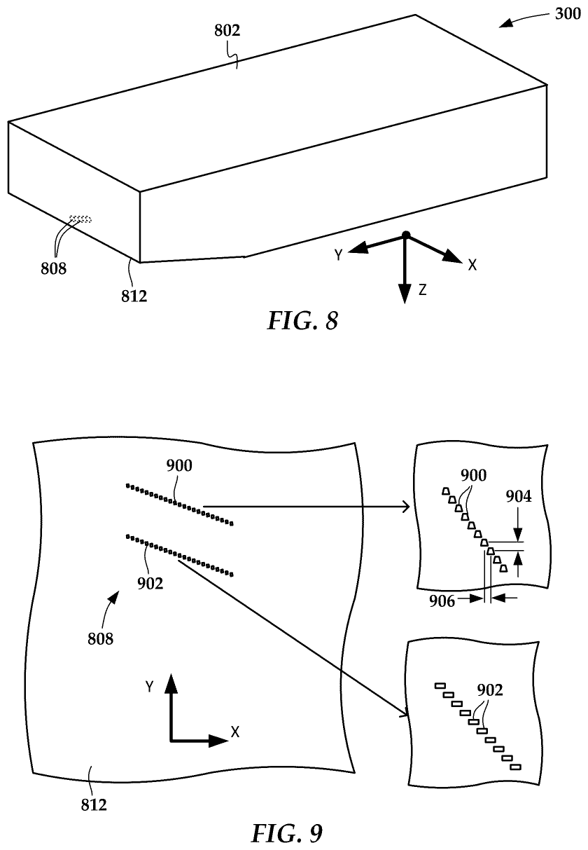

In FIG. 9, a diagram shows details of the read and write transducers 808 as seen from the media-facing surface 812 of the recording head 300. A linear array of write transducers 900 is located in a downtrack direction from a linear array of read transducers 902. As seen in the detail view at the upper right side of FIG. 9, the write transducers 900 are illustrated schematically as write poles, although the write transducers 900 may contain other components such as return poles, coils, yokes, shields, energy-assisted recording devices, etc. The lower right hand detail view shows the read transducers 902 as magnetoelectric stacks and the read transducers 902 may include other components such as side shields. While the illustration shows an equal number of write transducers 900 and read transducers 902, the numbers of respective transducers may be different (e.g., fewer write transducers 900 than read transducers 902) and the arrangement and geometry of transducers may be different than what is shown.

In any of the embodiments described above, the head load/unload can be ramp-less, contact start stop (CSS), suspension retract, piezo-based suspension retract. In these technologies, once the disks are spinning, one or more of the following may occur: retracting/relaxing the HGA suspension in the vertical direction (normal to the disk surface) to make contact with the media; moving the media spindle towards the heads in the vertical direction; using the flexure to move in the vertical direction; tilting of the HGA assembly using other methodologies, like a tilt motor, a collet or grippers to pull the HGA's back; using a slide-in ramp. The heads can be on the top and/or bottom surfaces of each disk and the reading from and writing to the disk can be one sided or both sided. For all systems number of heads are exemplary and can vary. Some scenarios show linear actuators, but these linear actuators are not limited to linear voice coils. For example, linear actuators can be rotary (e.g., leadscrew, rack and pinion), inchworm, etc.

In any of the embodiments above, a number of different techniques can be used to write data. Conventionally, tracks are written individually and are spaced apart so as not to induce adjacent track interference. In other techniques, tracks are written to partially overlap each other. In one example, shingled media recording (SMR) involves writing a group or band of tracks, such that the second track in the group overlaps the first track, the third track overlaps the second track, etc. This results in narrower tracks than could be written using the same write transducer to write conventional tracks.

Randomly updating tracks in an SMR band can be more time consuming than for conventional writing, as all the track in the group may need to be rewritten even if just one track is changed. Another issue with SMR is that as the head goes across the stroke between inner diameter and outer diameter of the disk, the track density gains (measured in tracks per inch, or TPI) vary. To make full use of both the inner diameter and outer diameter zones, a special writer may be used, e.g., a write transducer that is oriented and/or sized to write inner/outer tracks, while a second write transducer is oriented/sized to write middle tracks. While a zero skew system can alleviate these issues for SMR writing without multiple write transducers, one of the issues with a zero-skew is the fact that the head stack assembly (HSA) mass movement cannot track across the disk surface as quickly as a balanced rotary actuator, although microactuators can compensate for this to some extent. A zero-skew actuator may also have hysteresis and other issues that can affect TPI and data throughput, the latter being measured in input/output operations per second (IOPS).

A read/write head as shown in FIG. 9 with multiple write transducers 900 can be used to improve SMR performance on a jukebox system as shown in FIG. 1, as well as in a conventional HDD drive apparatus. Note for a jukebox, the transducer spacings can be such that it mainly increases parallelism and may not implement SMR. The multiple write transducers 900 can be configured to write overlapping adjacent tracks simultaneously. By carefully choosing the writer-to-writer downtrack spacing 904 and writer-to-writer crosstrack spacing 906, the write transducers can be physically laid out to write the desired overlapping tracks. To accomplish this, the data for multiple tracks are encoded and buffered, and the electrical signals sent to the write transducers 900 based on the encoded data are delayed when being sent to the writers. Thus, when the leading write transducer 900 records the first track in an SMR band and has moved on from the track starting point by distance corresponding to spacing 904, the adjacent writer can begin writing the second track which partially overlaps the first track. This is repeated for the remaining write transducers 900.

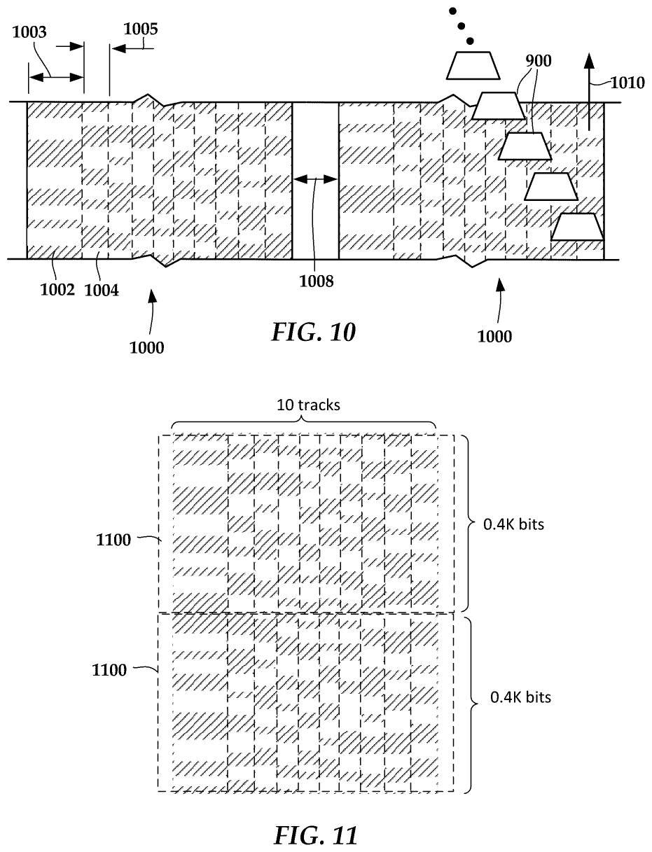

In FIG. 10, a block diagram shows shingled tracks according to an example embodiment. In this example, shaded or non-shaded block illustrate representative magnetic orientations within the tracks, which can be mapped to bit values 1 and 0. Two bands 1000 are shown, each band 1000 having multiple tracks. The tracks are written from right to left in the example, such that the last track 1002 in each band 1000 is on the left-hand side. The width 1003 of the last track is greater than a width 1005 of the other, overlapped tracks, as represented by track 1004. There is also space 1008 between the bands 1000, which is there to satisfy non-repeatable runout (NRRO) and on-cylinder limit (OCLIM) requirements.

As indicated in the right-hand side of FIG. 10, an array of write transducers 900 (only some of the transducers are shown) can write each band 1000 in a single pass, where the disk moves in the direction indicated by arrow 1010 relative to the write transducers 900. In some embodiments, a number of the write transducers 900 corresponds to a number of tracks in each SMR band 1000. This arrangement can increase throughput by about N times, where N is the number of write transducers (e.g., ˜10× for 10 write transducers). The data layout could be defined such that a data sector would be 4K/10×10 tracks, for example. An example of sectors 1100 of this size are shown in the schematic diagram of FIG. 11. This enables sectors to be erased and rewritten similar to how they are done in conventional magnetic recording (CMR). The bands 1000 could be read in a similar fashion using an array of read transducers 902 as show in FIG. 9.

To write, read and/or erase the sector in this fashion, a buffer could be used to buffer the data for the entire band 1000. This multiple writer and reader arrangement enables use of cross track encoding e.g., two-dimensional magnetic recording (TDMR), in which signals from multiple readers are combined. For example, a signal from two readers over the same track may be combined when reading the track, e.g., using multiple signal/sensor magnetic recording (MSMR) mode that uses two or more signals to read from a single track. In another example, a TDMR multi-track (TDMR-MT) mode involves one or more readers each reading from more than one track. Both MSMR and TDMR-MT modes are specific cases of TDMR. The multiple readers may be from the same transducer set or from different, adjacent transducer sets. The multiple readers may be configured for vector recording, or technologies that make use of readers of both longitudinal in the cross track and the perpendicular nature of the bits.

The spacing between individual read transducers 902 and write transducers 900 can be adjusted using heater-like systems, in which heaters cause thermal expansion and contraction between the transducers thereby adjusting relative spacing. For heater systems, the source of the heat could be electrical (e.g., resistor) or optical (e.g., laser). Other clearance actuators include piezo actuator, micromechanical, etc. In order to handle the increased amount of data, the preamplifier and flex circuits that couple the head or heads to a controller would be adapted to handle multiple signals to be carried simultaneously.

Interlaced magnetic recording (IMR) is another technique in which tracks are written to partially overlap each other. In IMR, a first set of lower tracks are written spaced apart from each other, and then an upper track is written between and partially overlapping two lower tracks. Typically, the lower tracks are written at a larger width than the upper tracks, and the overlapped writing of the upper tracks will reduce the width of the lower tracks. An IMR scheme can provide reduced track widths similar to SMR, but the penalty for random track updates in IMR is not as severe as it is for SMR. To ensure high areal density, an IMR recording head may need adaptations enabling the writing of different width tracks, e.g., multiple write poles, use of different HAMR power levels, etc.

In FIG. 11, a diagram shows an arrangement of write transducers 900 that can be used for IMR writing according to an example embodiment. The bottom row of transducers 900 can be used for higher linear density (as measured in kilobytes per inch, or KBPI), wider bottom tracks. The top row of transducers 900 can be used for writing top tracks with narrow widths, the top tracks being located between and partially overlapping two bottom tracks. In order to accommodate write coils for each of the transducers 900, alternate arrangements may be used that space out the write poles.

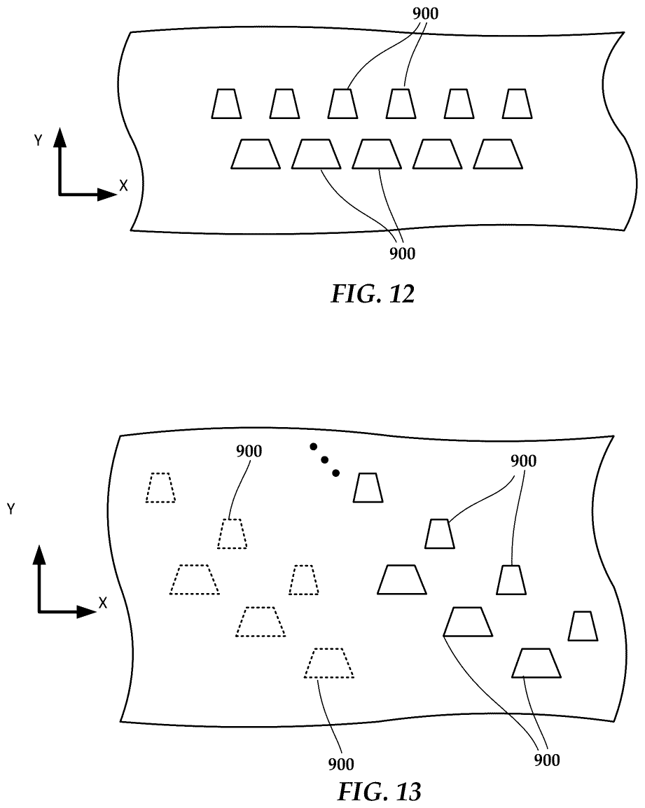

Spaced apart IMR write transducers 900 are shown in the right side of FIG. 13, which includes three wide write transducers 900 for the bottom tracks and four narrow write transducers 900 for the top tracks. The arrangement shown in FIG. 13 may be more expensive to fabricate than the structure shown in FIG. 12, as the same process steps need to be repeated for each downtrack-offset structure (the layers are built on the xz-plane). For the setup in FIG. 12, all of the write transducers 900 in a row are fabricated at the same time. In order to reduce processing costs, a hybrid arrangement can use a second set of staggered write transducers 900 as drawn in dotted lines in the lefthand side of FIG. 13. In this arrangement, some of the write transducers 900 are crosstrack aligned, and so can be formed during the same process steps. Another way to assemble these structures would be fabricate the write transducers separately on the same plane of a sacrificial wafer, and then remove and transfer print the write transducers onto the slider at various stages. These techniques could be used for assembling SMR type heads as well, e.g., as shown in FIG. 9.

For conventional magnetic recording, different track widths can be achieved due to the different write pole widths shown in FIGS. 12 and 13, which will affect the size of the fields applied to the disk. The size of the fields can be also influenced by other write transducer geometry, e.g., return pole geometry, number and arrangement of coils, etc. In other embodiments, such as a HAMR system, it is possible to design a solid immersion mirror, near field transducer, or other component that can produce different written track widths, such that the magnetic performance of the write transducers need not be significantly different. By changing a size of the laser hotspot during HAMR recording, e.g., by changing applied laser power and/or characteristics of the optical pathway, the written track size can vary for the same write transducer 900.

In some embodiments, a read/write head may be able to perform an IMR write using half the number of write transducers (using two passes instead of one) if the write transducers utilize HAMR. In such an embodiment, a single row of write transducers 900 as shown in FIG. 12 or 13 can be used to write IMR tracks over two revolutions. The tracks of the first revolution written using at higher KBPI using a hotspot that produces larger track widths. The tracks of a second revolution are then written partially overlapping the tracks of the first pass with a hotspot that produces narrower widths. A similar effect may be achieved by, for the different passes, adjusting write current, head-media spacing, disk rotation speed, or a combination thereof.

Calibration for the readers in downtrack, crosstrack, width, head-media spacing (HMS), and signal-to-noise ratio (SNR) can be achieved using traditional HDD servo index marks (SIM) or servo address mark (SAM) information along with another fixed frequency burst to calibrate HMS from the Wallace spacing equation, or other timing recovery marks that have similar features. Reader transducers 902 and write transducers 900 do not need to be crosstrack aligned and can be fabricated into a single head or slider or use a multiple slider arrangement. It is possible to implement vector recording in this fashion as well. Examples of vector recording are described in U.S. Pat. No. 10,490,219 and

Some advantages that the illustrated embodiments have over current SMR and IMR strategies include: random read/write/erase performance comparable to CMR; throughput for N-heads is about N-times faster than CMR/SMR; track widths are defined based on manufacturing spacing and integrated heater elements and therefore expected to be constant and compensate simultaneously for NRRO. In a zero-skew system, downtrack spacing between reader and writer is not so much of an issue, especially with read-while-write capability. Read-while-write capability is expected to enable multiple write poles to write simultaneously. This can also be implemented on a non-zero-skew system. In such a case, heaters or piezoelectric actuators may provide compensation for reader-to-reader and writer-to-writer spacings along the arc in the downtrack direction.

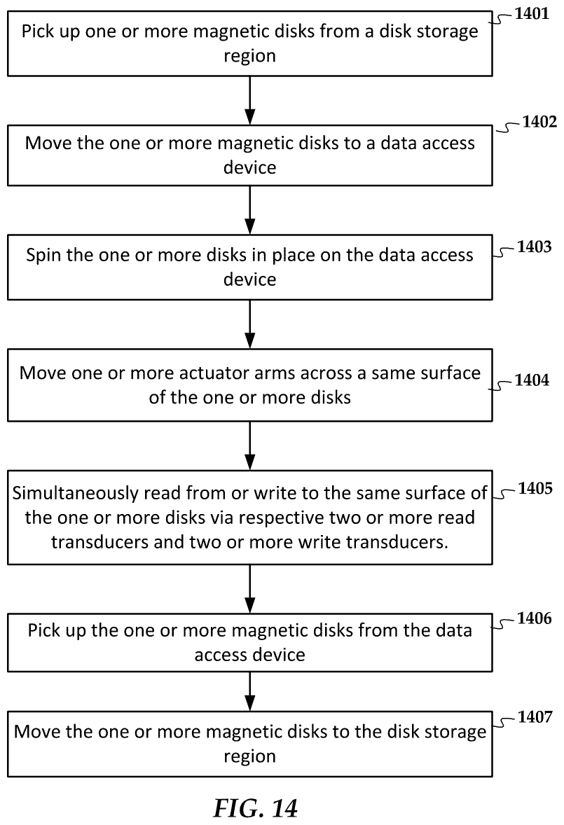

In FIG. 14, a flowchart illustrates a method according to an example embodiment. The method involves via a carrier mechanism, picking up 1401 one or more magnetic disks from a disk storage region and moving 1402 the one or more magnetic disks to a data access device. The system spins 1403 one or more disks in place on the data access device, and moves 1404 one or more actuator arms across a same surface of the one or more disks. The method further involves simultaneously reading from or writing to 1405 the same surface of the one or more disks via respective two or more read transducers and two or more write transducers. In one embodiment, the method further involves, via the carrier mechanism, picking up 1406 the one or more magnetic disks from the data access device and moving 1407 the one or more magnetic disks to the disk storage region.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor or multiple processors operating cooperatively. Such instructions may be stored on a non-transitory computer-readable medium and transferred to the processor for execution as is known in the art. The structures and procedures shown above are only a representative example of embodiments that can be used to provide the functions described hereinabove.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

What is claimed is:

1. A data storage apparatus, comprising:
a disk storage region in which a plurality of magnetic disks are stored;
a carrier mechanism for picking up one or more of the magnetic disks and moving the one or more magnetic disks to and from the disk storage region; and
a data access device comprising:
a structure to receive the one or more magnetic disks from the carrier mechanism and facilitate spinning the one or more magnetic disks in place;
one or more actuator arms operable to move across a same surface of the one or more magnetic disks;
two or more read transducers mounted to the one or more actuator arms and operable to simultaneously read from the same surface of the one or more magnetic disks; and
two or more write transducers mounted to the one or more actuator arms and operable to simultaneously write to the same surface of the one or more magnetic disks.

2. The data storage apparatus of claim 1, wherein the one or more actuator arms comprise two or more rotary arms that rotate about separate pivot axes.

3. The data storage apparatus of claim 1, wherein the one or more actuator arms comprise two or more linearly driven, zero-skew arms that move along two or more paths separately located around the one or more magnetic disks.

4. The data storage apparatus of claim 1, wherein the one or more actuator arms comprise two or more linearly driven, zero-skew arms that move along a common path.

5. The data storage apparatus of claim 1, wherein the one or more actuator arms comprise an arm with two or more head gimbal assemblies located at a distal end.

6. The data storage apparatus of claim 5, wherein the one or more actuator arms comprise linearly tracking arms.

7. The data storage apparatus of claim 5, wherein the one or more actuator arms comprise rotary arms.

8. The data storage apparatus of claim 1, wherein the two or more write transducers are integrated on a common head.

9. The data storage apparatus of claim 8, wherein the two or more write transducers are operable to simultaneously write partially overlapping tracks onto the same surface of the one or more magnetic disks.

10. The data storage apparatus of claim 9, wherein the partially overlapping tracks are written in shingled magnetic recording bands.

11. The data storage apparatus of claim 10, wherein a number of the two or more write transducers corresponds to a number of tracks in the shingled magnetic recording bands.

12. The data storage apparatus of claim 9, wherein the partially overlapping tracks are written as interlaced magnetic recording tracks.

13. The data storage apparatus of claim 12, wherein a first plurality of the two or more write transducers are configured for writing bottom tracks of the interlaced magnetic recording tracks and a second plurality of the two or more write transducers are configured for writing top tracks that each partially overlap one or more of the bottom tracks.

14. A method comprising:
via a carrier mechanism, picking up one or more magnetic disks from a disk storage region and moving the one or more magnetic disks to a data access device;
spinning the one or more magnetic disks in place on the data access device;
moving one or more actuator arms across a same surface of the one or more magnetic disks; and
simultaneously reading from or writing to the same surface of the one or more magnetic disks via respective two or more read transducers and two or more write transducers.

15. The method of claim 14, further comprising, via the carrier mechanism, picking up the one or more magnetic disks from the data access device and moving the one or more magnetic disks to the disk storage region.

16. The method of claim 14, wherein writing to the same surface of the one or more magnetic disks comprises simultaneously writing partially overlapping tracks onto the same surface of the one or more magnetic disks via the two or more write transducers.

17. The method of claim 16, wherein the partially overlapping tracks are written in shingled magnetic recording bands.

18. The method of claim 17, wherein a number of the two or more write transducers corresponds to a number of tracks in the shingled magnetic recording bands.

19. The method of claim 16, wherein the partially overlapping tracks are written as interlaced magnetic recording tracks.

20. The method of claim 19, wherein a first plurality of the two or more write transducers are configured for writing bottom tracks of the interlaced magnetic recording tracks and a second plurality of the two or more write transducers are configured for writing top tracks that each partially overlap one or more of the bottom tracks.
